(19) United States
(12) Patent Application Publication
(10) Pub. No.: US 2007/0299180 A1
(43) Pub. Date: Dec. 27, 2007

(54) HIGH SOLIDS EMULSIONS

(75) Inventor: John A. Joecken, Richfield, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 11/767,073

(22) Filed: Jun. 22, 2007

Related U.S. Application Data
(60) Provisional application No. 60/805,682, filed on Jun. 23, 2006.

(51) Int. Cl. C08K 5/06

(52) U.S. Cl. 524/376; 524/556

(57) ABSTRACT

A polymeric binder composition suitable for use in an adhesive, caulk, sealant or coating, for improved dry time, freeze-thaw stability, flexibility, effluorescence, alkali resistance, dirt resistance, elasticity, tensile elongation, durability, fade retention, scrub resistance, and low temperature application. A polymeric binder suitable for use in coating compositions for architectural, roof, OEM, industrial, traffic, masonry, wall and floor coatings applications. The latex binder comprises reaction products of ethylenically unsaturated monomers, polymerizable alkoxylated surfactant monomers in combination with polyalkylene glycol methacrylate and fatty alcohol ethoxylates surfactants. In accordance with this invention, embodiments utilizing glycidyl methacrylate or acetoacetoxy ethyl methacrylate are also possible.

### CROSS-REFERENCE TO RELATED APPLICATION

This application claims the benefit of U.S. provisional patent application No. 60/805,682 filed on Jun. 23, 2006, the entirety of which is hereby incorporated by reference.

It is an object of the present invention to provide a polymeric binder composition suitable for use in an adhesive, caulk, sealant or coating, for improved dry time, freeze-thaw stability, flexibility, effluorescence, alkali resistance, dirt resistance, elasticity, tensile elongation, durability, fade retention, scrub resistance, and low temperature application. In accordance with this invention, there is provided a polymeric binder suitable for use in coating compositions for architectural, roof, OEM, industrial, traffic, masonry, wall and floor coatings applications. The polymeric binder of this invention may also be suitable for use in caulks and sealants. This invention is directed to latex binders comprising reaction products of ethylenically unsaturated monomers, polymerizable alkoxylated surfactant monomers in combination with polyalkylene glycol methacrylate and fatty alcohol ethoxylates surfactants. In accordance with this invention, embodiments utilizing glycidyl methacrylate or acetoacetoxy ethyl methacrylate are also possible.

It is another object of the present invention to provide a coating composition comprising a latex binder, wherein the latex binder comprises the reaction products of ethylenically unsaturated monomers, polymerizable alkoxylated surfactant monomers in combination with polyalkylene glycol methacrylate and fatty alcohol ethoxylates surfactants. Other functional monomers such as glycidyl methacrylate, acetoacetoxy ethyl methacrylate, diacetone acrylamide/adipic dihydrazide, carbodiimide, and allyl ether can be part of the polymer matrix to give unique performance features.

In yet another aspect of the present invention, there is provided a method of forming a latex emulsion polymer from a monomer mixture comprising reaction products of ethylenically unsaturated monomers, polymerizable alkoxylated surfactant monomers in combination with polyalkylene glycol methacrylate and fatty alcohol ethoxylates surfactants. The monomer mixture can also include specialty monomers such as glycidyl methacrylate, acetoacetoxy ethyl methacrylate, diacetone acrylamide/adipic dihydrazide.

### DETAILED DESCRIPTION OF THE INVENTION

This invention is directed to a polymeric binder suitable for use in a coating, adhesive, caulk, or sealant composition. The polymerization binder is an emulsion-polymerization reaction product of a monomer mixture comprising:
a) from 0.5 to 8.0 weight percent, based on the weight of the monomer mixture, ethylenically unsaturated monomers comprising at least one ethylenically unsaturated carboxylic acid functional monomer;
b) from 0.20 to 2.0 weight percent, based on the weight of the mixture, of at least one polymerizable surfactant monomer;
c) from 0 to 2.0 weight percent, based on the weight of the mixture, of at least one polyalkylene glycol methacrylate; and
d) from 0.2 to 1.0 weight percent, based on the weight of the mixture, of an anionic polyoxyalkylate fatty alcohol surfactant.

The polymeric binder of this invention has a nonvolatile materials content greater than 50% reaction product of a monomer mixture comprising:

In one embodiment, the polyalkylene glycol methacrylate is polyethylene glycol methacrylate having an average of 7 moles of ethylene oxide units per molecule and having an average molecular weight of about 400-500 g/mol.

In an alternative embodiment, a glycidyl methacrylate is used in place of the polyalkylene glycol methacrylate.

### Ethylenically Unsaturated Monomers

The ethylenically unsaturated carboxylic acid functional monomers are preferably C3 to C20 ethylenically unsaturated carboxylic acids such as monomers selected from the group consisting of acrylic acid, methacrylic acid, itaconic acid, fumaric acid, maleic acid and anhydrides of such acids; and mixtures of such monomers.

The amount of ethylenically unsaturated carboxylic acid monomer in the monomer mix can be from 0.5 to 8.0 weight percent, based on the weight of the mixture.

Other ethylenically unsaturated monomers suitable for use in the monomer mix include one or more monomers selected from, but not limited to: substituted, e.g., hydroxy- or acetoacetoxy-substituted and unsubstituted (C1 to C50) alkyl(meth)acrylates, styrene and substituted styrenes, vinyl acrylates, vinyl acetates, fluoromethacrylates, acrylamide, substituted acrylamides, methacrylamides, substituted methacrylamides, and combinations thereof. Among the esters of acrylic acid and methacrylic acid, monomers include methyl acrylate, ethyl acrylate, propyl acrylate, butyl acrylate, ethylhexyl acrylate, lauryl acrylate, methyl methacrylate, ethyl methacrylate, propyl methacrylate, butyl methacrylate, lauryl methacylate, isobutylene methacrylate, styrene, acrylamide, vinyl acrylate, vinyl acetate, hydroxyethyl acrylate and hydroxyethyl methacrylate. In addition, crosslinking monomers can be incorporated into the latex such as acetoacetoxyethyl methacrylate, diacetoneacrylamide adipic dihydrazide combinations, multifunctional acrylate and methacrylate monomer and oxidatively crosslinking monomers.

### Polymerizable Surfactant Monomers

Polymerizable surfactant monomers are surface active compounds having a polymerizable group, such as an allyl, acryl methacryl or methallyl group, and which may be used as an emulsifier in an emulsion polymerization. Thus, the polymerizable surfactant functions as both a surfactant and as a comonomer. The polymerizable surfactant may be cationic, anionic or nonionic and may be a non-migratory surfactant that has the ability to fix itself onto the surface of a latex particle such as, for example, by formation of a covalent bond. Typically, the reactions between polymerizable surfactants and the latex particle are sufficiently strong to prevent separation and migration therebetween. Suitable polymerizable surfactant monomers can comprise hydrophobic and hydrophilic functional groups, which also comprise polymerizable groups within it. For example, a polymerizable surfactant monomer comprising a hydrophilic functional group comprising a polymerizable group within it can be selected from the group consisting of allyl ammonium alkylether-sulfate (for example, as Polystep NMS-7 from Stepan Chemical), Polystep NMS-9, or allyl polyoxyethylene oxypropylene sulphate ammonium salt, such as Emulsogen APG-2019. The polymerizable reactive group can be selected based on the reactive species of the latex monomer. For example, acrylate reactive groups can be selected as reactive groups for use with vinyl, acrylic and styrenic monomers. A representative polymerizable surfactant for such a reaction is MAXEMUL 6106 (available from Uniqema) which has both phosphonate ester and ethoxy hydrophilicity.

The amount of polymerizable surfactant monomer in the monomer mix is about 0.5 weight percent to about 2.0 weight percent, based on the total weight of the monomer mixture. The incorporation of polymerizable surfactants reduces the water sensitivity of the latex and resulting coatings that use the latex made with polymerizable surfactants. By comparison, a latex made with a conventional migrating surfactant exhibits greater water sensitivity due to loss of surfactant from the latex particles. Coatings that contain a latex with polymerizable surfactants exhibit much greater water resistance and consequently significantly improved scrub resistance, as well as improved blister resistance and water immersion resistance. Due to the improved water resistance of these latex products, improvements in alkali and basic salts resistance is also significantly improved versus a latex made with conventional, migratory surfactants. In addition, the incorporation of certain glycolic polymerizable surfactants permit a reduction in the amount of coalescing agents needed to develop a fully coalesced film on application. By acting as internally coalescing agents, the polymerizable surfactant stabilized latex also improves the low temperature application performance of coatings, especially high film build coatings applied at 10-30 mil wet film thicknesses, such as horizontal and vertical masonry coatings and traffic paint applications. Additionally, incorporation of polymerizable surfactants in latex dramatically improves the surface and through dry time required for high film build coatings, and permits use of such latex products in rapid dry time applications such as traffic marking paints.

### Polyalkylene Glycol Methacrylate

A polyalkylene glycol methacrylate monomer is also employed as a reactant in the acrylic emulsion, as well as an anionic surfactant in order for the ethylenically unsaturated monomers to become dispersed in and incorporated in water and to enhance the latex storage and heat stability. The polyalkylene glycol methacrylate monomer includes an ethoxy group (CH2CH2O) or propoxy group which promotes the solubility and miscibility of the entire monomer in water. The polyalkylene glycol methacrylate monomer is selected from the group consisting of polyethylene glycol methacrylate, polypropylene glycol methacrylate, and mixtures thereof, having an average of 7 ethylene oxide (or propylene oxide) units per molecule. The polyalkylene glycol methacrylate monomer is present in an amount from 0 to 2.0 weight percent, based on the total weight of the monomer composition.

In some applications, the use of glycidyl methacrylate has been found advantageous, especially for floor coatings, where adhesion is improved due to the epoxy functional moieties.

### Fatty Alcohol Alkoxylate

In accordance with this invention, the ethoxylates derived from fatty alcohols, of the general formula RO—(C2-CH2-O)n-H, where n=4-15 are used to impart storage and heat stability to the latex. Particularly useful are the strongly polar terminal ester groups on the surfactant, such as a phosphate ester of an alkoxylated aliphatic alcohol (for example, KLEARFAC AA270, commercially available by BASF Corporation) that would likely also aid water miscibility. The fatty alcohol alkoxylate is typically present in the monomer mixture in an amount from greater than 0 to about 2.0 weight percent, based on the total monomer weight.

### Organofunctional Silane

In another embodiment of this invention, an organofunctional silane can be included along with the monomer mixture of the binder. By way of non-limiting example, the organofunctional silane can be added to the monomer mixture The acrylates and methacrylates of vinylsilanes can be particularly useful silanes for making the present coating compositions. Suitable silanes are commercially available from a variety of suppliers. Representative non-limiting examples of suitable silanes include: allyltrimethoxysilane; allyltrimethylsilane; N-(2-aminoethyl)-3-aminopropyl-methyldimethoxysilane; N-2-aminoethyl-3-aminopropyltrimethoxysilane; 3-aminopropylmethyldiethoxysilane; 3-aminopropyltriethoxysilane; 3-aminopropyltrimethoxysilane; bis-(dimethylamino)dimethylsilane; bis-(n-methylbenzamide)ethoxymethylsilane; bis(trimethylsilyl)acetamide; n-butyldimethylchlorosilane; t-butyldimethylchlorosilane; chloromethyltrimethylsilane; 3-chloropropyltriethoxysilane; 3-chloropropyltrimethoxysilane; di-t-butoxydiacetoxysilane; n,n-diethylaminotrimethylsilane; dimethylchlorosilane; dimethyldichlorosilane; dimethyldiethoxysilane; dimethylethoxysilane; dimethylethoxysilane; dimethyloctadecylchlorosilane; diphenyldimethoxysilane; 1,3-divinyltetramethyldisilazne; 1,3-divinyltetramethyldisiloxane; ethyltriacetoxysilane; (3-glycidoxypropyl)methyldiethoxysilane; (3-glycidoxylpropyl)trimethoxysilane; hexamethyldisilane; isobutyltrimethoxysilane; 3-mercaptopropylmethyldimethoxysilane; 3-mercaptopropyltrimethoxysilane; 3-mercaptopropyltriethoxysilane; 3-methacryloxypropyltrimethoxysilane; 3-methacryloxypropyltris(methylsiloxy)silane, n-methylaminopropyltrimethoxysilane; methylcyclohexydichlorosilane; methylcyclohexyldimethoxysilane; methyltriacetoxysilane; methyltrichlorosilane; methyltriethoxysilane; methyltrimethoxysilane; n-methyl-n-trimethylsilyltrifluoroacetamide; octadecyltrichlorosilane; octyltrichlorosilane; n-octyltriethoxysilane; phenylriethoxysilane; phenyltrimethoxysilane; tetra-n-butoxysilane; tetrachlorosilane; tetraethoxysilane (teos); tetrakis (2-ethoxyethoxy)silane; tetrakis (2-methoxyethoxy)silane; tetramethoxysilane; tetrapropoxysilane; trichlorosilane; triethylchlorosilane; triethylsilane; trimethoxysilylpropyldiethylenetriamine; n-trimethoxysilylpropyl-n,n,n-trimethyl ammonium chloride; trimethylbromosilane; trimethylchlorosilane; trimethylsilylacetamide; trimethylsilyliodide; trimethylsilylnitrile; trimethylsilyl trifluoromethanesulfonate; vinyldimethylchlorosilane; vinylmethyldichlorosilane; vinylmethyldiethoxysilane; vinyltrichlorosilane; vinyltriethoxysilane; vinyltriethoxysilane; and vinyltris(2-methoxyethoxy)silane.

### Preparation of the Latex Binder

The latex binder may be prepared by conventional emulsion polymerization techniques known in the art and include direct bulk emulsion, pre-emulsion seed or multiple stage polymerization. In one embodiment, the binder comprises an addition copolymer of styrene, butyl acrylate, methyl methacrylate, 2-ethylhexyl acrylate, methacrylic acid, allyl ammonium alkylether-sulfate, KLEARFAC AA270 and fatty alcohol ethoxylate.

The binder may be incorporated in a coating composition comprising, for example, pigment, binder and an aqueous medium. The binder can be present at a level of 25 to 45 weight percent, relative to the total weight of the coating composition. Selection of the suitable mixture for the coating composition using the binder of the present invention depends upon the requirements of the specific coating being formulated, such as the drying time required, pigment used and type of substrate onto which the coating will be utilized. The coating composition of this invention may further comprise additional components including without limitation, humectants, dispersants, penetrants, chelating agents, cosolvents, defoamers, buffers, biocides, fungicides, viscosity modifiers, bactericides, all of which are known in the art. Coating compositions of this invention have a volatile organic content of less than 100 grams/liter.

This invention is illustrated by the following examples that are merely for the purpose of illustration and are not to be regarded as limiting the scope of the invention or the manner in which it can be practiced. Unless specifically indicated otherwise, parts and percentages are given by weight.

### EXAMPLES

The following is a procedure to prepare the latex samples of this invention:

To a three neck flask equipped with mechanical stir blade, condenser and nitrogen purge inlet is charged, 866.26 g deionized water, 0.25 g sodium carbonate buffer, 3.16 g ammonium persulfate initiator and 2.26 g alkylethoxy allyl amine sulfate surfactant (Polystep NMS-7). The reactor is vessel is heated to 80 C while stirring, after which a monomer feed comprised of 263.94 g styrene, 462.46 g methylmethacrylate, 439.90 g methyl methacrylate, 131.97 g 2-ethylhexyl acrylate and 20.30 g methacrylic acid is feed over 3 hrs into the reactor. Simultaneously, a mixture of 75.10 g deionized water, 4.47 g sodium carbonate buffer, 113.70 g alkylethoxy allyl amine sulfate surfactant (Polystep NMS-7), 8.57 g ammonium hydroxide and 1.80 g ammonium persulfate is added over 3 hrs to into the reactor. 12.52 g deionized water is used as line rinse. The reaction mixture is held for 30 min at 80 C upon completion of the monomer and surfactant feeds. A post-polymerization initiation consisting of 3.76 g t-butyl hydroperoxide in 20.08 g deionized water and separately 2.67 g sodium metabisulfite in 20.08 g deionized water are fed into the reactor at 70° C. over 1 hr and then held at 70° C. for additional 30 min. The latex pH is adjusted with 7.13 g ammonium hydroxide and 3.61 g benzisothiazolinone (Proxel GXL) in 11.28 g deionized water. The resulting latex has the following physical properties: 55.00% weight solids, 8.81 lb/gal density, 175 nm particle size (Malvern instruments), 9.06 pH and 2600 cps viscosity (Brookfield, DV-1, #3, 30 rpm).

Latex examples 1-9, 14-16, 17 were made in a fashion similar to the above mentioned latex process.

### Preparation of Latexes

### Examples 1-9

Nine latex binders were prepared using the procedure above with the following weight percents of monomers, based on the total monomer weight, and additives:

TABLE 1
Preparation of Latex Binders - Examples 1-9

| Monomer | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Styrene | 20.02 | 20.02 | 20.02 | 19.87 | 19.92 | 45.00 | 20.02 | — | 20.01 |
| Butyl | 35.07 | 35.07 | 35.07 | 34.81 | 34.90 | 38.00 | 35.07 | 34.98 | 35.07 |
| Acrylate | | | | | | | | | |
| Methyl | 33.36 | 33.36 | 33.36 | 33.11 | 33.19 | — | 33.36 | 53.06 | 33.36 |
| Methacrylate | | | | | | | | | |
| 2-Ethylhexyl | 10.01 | 10.01 | 10.01 | 9.93 | 9.96 | 10.00 | 10.01 | 9.96 | 10.01 |
| Acrylate | | | | | | | | | |
| Polyethylene | — | — | — | — | 0.50 | — | — | 0.49 | — |
| Glycol | | | | | | | | | |
| Methacrylate | | | | | | | | | |
| Methacrylic | 1.54 | 1.54 | 1.54 | 1.53 | 1.53 | 7.00 | 1.54 | 1.51 | 0.80 |
| Acid | | | | | | | | | |
| Klearfac | — | — | — | 0.50 | 0.50 | — | 0.50 | 0.50 | 0.70 |
| AA270 | | | | | | | | | |
| Polystep | 2.20 | — | 1.10 | — | 1.00 | — | 0.50 | 0.99 | 0.70 |
| NMS-7 | | | | | | | | | |
| Emulsogen | — | 2.21 | 1.10 | — | — | — | — | — | — |
| APG2019 | | | | | | | | | |
| Polystep | — | — | — | — | — | 2.14 | — | — | — |
| NMS-9 | | | | | | | | | |
| Glycidyl | — | — | — | 0.75 | — | — | — | — | 0.75 |
| Methacrylate | | | | | | | | | |
| Tg ° C. | 11.0 | 11.0 | 11.0 | 13.2 | 11.0 | 8.0 | 11.0 | 12.9 | 11.0 |
| Particle size | 190 | 247 | 238 | 163 | 178 | 127 | 147 | 206 | 181 |
| (nm) | | | | | | | | | |
| % NVM | 54.99 | 55.08 | 55.10 | 54.99 | 55.00 | 49.82 | 55.00 | 54.66 | 54.50 |

### Latex Example 10

To a three neck flask equipped with mechanical stir blade, condensor and nitrogen purge inlet is charged, 394.26 g deionized water and 2.51 g Polystep NMS-7 the reactor is heated to 80 C. A pre-emulsion is generated by mixing 486.55 g deionized water, 7.82 g Klearfac AA-270, 4.97 g ammonium hydroxide, 24.00 g Polystep NMS-7, 266.63 g styrene, 467.17 g n-butyl acrylate, 444.38 g methyl methacrylate, 133.32 g 2-ethylhexyl acrylate, 6.72 g Rohamere D1143 and 20.51 g methacrylic acid. At pH 5.0-6.0, a stable emulsion is formed. A 3% wt addition of the pre-emulsion is added to the reactor at 80° C. A 6% addition of 12.54 g ammonium persulfate in 120.38 g deionized water is subsequently added to the reactor. The reaction is held at 80 C for 20 min. The remaining pre-emulsion and initiator materials are fed over 3 hrs. Subsequently, the reaction is cooled to 70° C. A post-polymerization initiation consisting of 3.71 g t-butyl hydroperoxide in 30.09 g deionized water and separately 2.61 g sodium metabisulfite in 30.09 g deionized water are added to the reactor over 1 hr. The latex is adjusted with 12.04 g ammonium hydroxide and 3.61 g benzisothiazolinone (Proxel GXL). The resultant latex physical properties are 54.82% weight solids, 8.50 lb/gal density, 156 nm particle size (Malvern instrument), 8.67 pH, 1048 cps (Brookfield, DV-1, #3, 30 rpm).

Latex examples 10-13 were made in the above-mentioned manner.

### Latex Example 17

To a three neck flask equipped with mechanical stir blade, condensor and nitrogen purge inlet is charged, 1098.49 g deionized water, 0.36 g sodium carbonate buffer, 1.43 g Rhodapex EST-30 anionic surfactant and 3.60 g ammonium persulfate dissolved in 3.60 g deionized water. The reactor is vessel is heated to 80° C. while stirring, after which a monomer feed comprised of 769.85 g styrene, 603.30 g butyl methacrylate, 158.76 g 2-ethylhexyl acrylate and 55.57 g methacrylic acid is feed over 3 hrs into the reactor. Simultaneously, a mixture of 108.24 g deionized water, 16.59 g Klearfac AA-270, 5.56 g sodium carbonate buffer, 40.16 g Rhodapex EST-30 anionic surfactant, 10.11 g ammonium hydroxide and 2.02 g ammonium persulfate is added over 3 hrs to into the reactor. 12.52 g deionized water is used as line rinse. The reaction mixture is held for 30 min at 80 C upon completion of the monomer and surfactant feeds. A post-polymerization initiation consisting of 4.55 g t-butyl hydroperoxide in 25.03 g deionized water and separately 3.25 g sodium metabisulfite in 25.03 g deionized water are fed into the reactor at 70° C. over 1 hr and then held at 70° C. for additional 30 min. The latex pH is adjusted with 19.51 g ammonium hydroxide and 12.02 g benzisothiazolinone (Proxel GXL) in 18.73 g deionized water. The resulting latex has the following physical properties: 55.00% weight solids, 8.56 lb/gal density, 200 nm particle size (Malvern instruments), 9.30 pH and 744 cps viscosity (Brookfield, DV-1, #3, 30 rpm).

TABLE 2
Preparation of Latex Binders - Examples 10-25

| Monomer | Ex. 10 | Ex. 11 | Ex. 12 | Ex 13 | Ex 14 | Ex 15 | Ex 16 | Ex 17 |
|---|---|---|---|---|---|---|---|---|
| Styrene | 19.92 | 20.02 | 20.02 | 20.01 | 20.00 | 20.02 | 19.92 | 48.50 |
| Butyl Acrylate | 34.90 | 35.07 | — | — | 49.00 | 35.07 | 34.90 | 38.00 |
| Methyl | 33.19 | 33.36 | 25.44 | 25.45 | 20.00 | 28.36 | 33.19 | — |
| Methacrylate | | | | | | | | |
| 2-Ethylhexyl | 9.96 | 10.01 | 49.55 | 50.00 | — | 15.01 | 9.96 | 10.00 |
| Acrylate | | | | | | | | |
| Polyethylene | 0.50 | — | — | — | — | — | 0.50 | — |
| Glycol | | | | | | | | |
| Methacrylate | | | | | | | | |
| Methacrylic | 1.53 | 1.54 | 2.01 | 1.54 | 2.00 | 1.54 | 1.53 | 3.50 |
| Acid | | | | | | | | |
| Klearfac AA270 | 0.50 | 1.50 | 0.50 | 1.50 | 1.50 | 0.50 | 0.50 | 0.89 |
| Polystep NMS-7 | 0.50 | 0.50 | 0.50 | 0.50 | 0.50 | 0.50 | 1.00 | — |
| Rhodapex | — | — | — | — | — | — | — | 0.79 |
| EST-30 | | | | | | | | |
| AAEM | — | — | 3.00 | 3.00 | 9.00 | — | — | — |
| Tg ° C. | 11.0 | 11.0 | −0.1 C. | −1.0 | −0.4 | 6.0 | 11.0 | 6.6 |
| Particle size | 156 | 249 | 249 | 175 | 224 | 167 | 232 | 200 |
| (nm) | | | | | | | | |
| % NVM | 54.99 | 50.00 | 54.13 | 53.64 | 54.15 | 54.78 | 54.52 | 55.00 |

| | | | | | Ex. 22 | | Ex. 23 | | Ex. 24 | | |
|---|---|---|---|---|---|---|---|---|---|---|---|
| | | | | | Stage | Stage | Stage | Stage | Stage | Stage | |
| Monomer | Ex. 18 | Ex. 19 | Ex. 20 | Ex. 21 | 1 | 2 | 1 | 2 | 1 | 2 | Ex. 25 |
| Styrene | 20.02 | 38.00 | 37.24 | 47.53 | 40.00 | 19.91 | 19.40 | 19.53 | 20.01 | 18.41 | 20.02 |
| Butyl | 35.07 | 48.50 | 47.53 | 37.24 | — | 38.32 | 32.98 | — | 34.01 | — | 35.07 |
| Acrylate | | | | | | | | | | | |
| Methyl | 33.36 | — | — | — | 31.46 | 20.84 | 6.26 | 51.00 | 6.45 | 48.81 | 33.36 |
| Methacrylate | | | | | | | | | | | |
| 2-Ethylhexyl | 10.01 | 10.01 | 9.81 | 9.81 | 27.00 | 18.90 | 36.86 | 27.45 | 38.00 | 25.80 | 10.01 |
| Acrylate | | | | | | | | | | | |
| Polyethylene | — | — | — | — | — | 0.49 | — | 0.48 | — | 0.49 | — |
| Glycol | | | | | | | | | | | |
| Methacrylate | | | | | | | | | | | |
| Methacrylic | 1.54 | 3.50 | 3.43 | 3.43 | 1.54 | 1.53 | 1.50 | 1.54 | 1.54 | 1.46 | 1.54 |
| Acid | | | | | | | | | | | |
| AAEM | — | — | — | — | — | — | 3.01 | — | — | — | — |
| Klearfac | 0.40 | 0.89 | 0.87 | 0.87 | 1.43 | 0.51 | 1.37 | 0.50 | 1.37 | 0.49 | 0.40 |
| AA270 | | | | | | | | | | | |
| Polystep | 0.50 | — | — | — | — | — | — | — | — | — | 0.40 |
| NMS-7 | | | | | | | | | | | |
| Rhodapex | — | 0.76 | 0.74 | 0.74 | 0.35 | — | 0.41 | — | 0.41 | — | — |
| EST-30 | | | | | | | | | | | |
| Coatosil | — | — | 2.00 | 2.00 | — | — | — | — | — | 5.02 | — |
| 1757 | | | | | | | | | | | |
| Tg ° C. | 11.0 | 14.0 C. | 14.0 | 12.2 | 21.0 | | −0.10 | | 21.0 | | 12.0 |
| Particle size | 170 | 180 | 184 | 183 | 207 | | 268 | | 196 | | 220 |
| (nm) | | | | | | | | | | | |
| % NVM | 54.00 | 54.50 | 54.50 | 54.00 | 54.02 | | 54.20 | | 54.35 | | 59.45 |

### Latex Example 24

To a three neck flask equipped with mechanical stir blade, condensor and nitrogen purge inlet is charged, 455.39 g deionized water, 0.45 g Klearfac AA-270, 0.10 g ammonium hydroxide and 1.05 g sodium carbonate. The reactor vessel is heated to 80 C while stirring. A first pre-emulsion is prepared by adding to 218.07 g deionized water, 11.16 g Klearfac AA-270, 2.57 g ammonium hydroxide, 0.38 g sodium carbonate, 9.49 g Rhodapex EST-30 and mixing followed by 138.54 g styrene, 235.52 g n-butyl acrylate, 44.64 g methylmethacrylate, 263.10 g 2-ethylhexyl acrylate and 10.65 g methacrylic acid. The first pre-emulsion is added to the charge solution over 2 hrs along with a mixture of 8.59 g ammonium persulfate dissolved in 128.28 g deionized water. After a 30 min hold period, a second pre-emulsion consisting of 278.36 g deionized water, 5.26 g Klearfac AA-270 is mixed followed by 4.85 g ammonium hydroxide, 169.33 g styrene, 448.97 g methylmethacrylate, 237.31 g 2-ethylhexyl acrylate, 4.49 g Rohamere D1143, 6.18 g Coatosil 1757 and 13.47 g methacrylic acid, is added over 2 hrs along with 9.24 g ammonium persulfate dissolved in 119.30 g deionized water. The reaction is held for 30 min. and then cooled to 70° C. A post-polymerization initiation consisting of 3.28 g sodium metabisulfite dissolved in 25.66 g deionized water and separately 4.72 g t-butyl hydroperoxide in 25.66 g deionized water are added over 45 min. The latex is cooled to 45° C. and adjusted with 21.81 g ammonium hydroxide and 10.45 g benzisothiazolinone (Proxel GXL). The latex physical properties are listed below: 54.35% weight solids, 8.70 lb/gal density, 196 nm particle size (Malvern instrument), 9.21 pH, 580 cps (Brookfield DV-1, #3, 30 rpm).

Latex examples 22-24 were made in the above manner.

### Example 26

### Paint Composition

The following paint composition was prepared utilizing the latex of Example 8 above.

| Component | Weight % |
|---|---|
| Latex of Example 8 | 43.16 |
| Water | 6.19 |
| Defoamer | 0.33 |
| Tamol 963 | 0.77 |
| Igepal CO-630 | 0.23 |
| Proxel GXL biocide | 0.02 |
| HEC Thickener | 0.02 |
| Titanium dioxide | 2.11 |
| Camelcarb | 35.67 |
| Defoamer | 0.33 |

The total non-volatile material content of Example 25 is 76.35%.

### Example 27

### Masonry Coating

| Component | Weight % |
|---|---|
| Latex of example 21 | 38.15 |
| Water | 18.89 |
| Defoamer | 0.87 |
| Attapulgite clay | 0.22 |
| TKPP | 0.04 |
| Zinc oxide | 2.19 |
| Tamol 681 | 0.79 |
| Triton CF-10 | 0.35 |
| HEC thickener | 0.43 |
| Titanium dioxide | 13.15 |
| Silica | 7.54 |
| Mica | 3.33 |
| Texanol | 2.3 |
| Aqueous ammonia | 0.13 |

### Example 28

### Elastomeric Roof Coating

| Component | Weight % |
|---|---|
| Latex of example 21 | 41.67 |
| Water | 12.8 |
| Tamol 850 | 0.38 |
| TKPP | 0.11 |
| Zinc oxide | 2.57 |
| Calcium carbonate | 34.05 |
| Titamium dioxide | 5.58 |
| Defoamer | 0.3 |
| Texanol | 0.55 |
| Proxel GXL | 0.17 |
| Aqueous ammonia | 0.08 |
| Propylene glycol | 1.23 |
| HEC thickener | 0.51 |

The examples described below in Table 3 are intended to show the effect of using a polymeric binders of this invention in high film build fast drying traffic latex paints and Table 4 shows performance in high film build masonry coatings.

TABLE 3
Traffic marking paint performance.

| | | Particle | | | | | |
|---|---|---|---|---|---|---|---|
| | | size | | Level | DNPU time | Film | Scrub |
| Latex | Description | nm | Cosolvent | % latex solids | min | condition | % of control |
| Control | Conventional surfactants | 190 | Texanol/BuCarb | 4.50/4.50% | 12 | cracks | 100% |
| Control | Crosslinking latex with conventional surfactants | 200 | Texanol/BuCarb | 4.50/4.50% | 15 | | 121% |
| Ex 1 | 2.20% NMS7 | 175 | None | 0.00% | 14 | excellent | 100% |
| Ex 2 | 2.45% APG2019 | 247 | None | 0.00% | 10 | cracks | 37% |
| | | | Texanol/BuCarb | 4.50/4.50% | 13 | excellent | 129% |
| Ex 3 | 1.10% APG2019/1.10% AA270 | 238 | None | 0.00% | 13 | cracks | 74% |
| Ex 4 | 0.75% NMS7/0.25% APG2019/1.0% AA270 | 192 | None | 0.00% | 13 | cracks | 62% |
| Ex 5 | 10% NMS7/0.10% AA270 | 137 | None | 0.00% | 12 | cracks | 26% |
| | | | Texanol | 4.50% | 13 | excellent | |
| | | | Butyl carbitol | 4.50% | 12 | excellent | |
| | | | Butyl carbitol | 2.50% | 7 | few cracks | |
| Ex 6 | 2.0% NMS7/0.10% AA270 | 127 | None | 0.00% | 13 | cracks | |
| | | | Texanol | 4.50% | 14 | excellent | |
| | | | Butyl carbitol | 4.50% | 12 | excellent | |
| Ex 7 | 1.0% NMS7/1.0% AA270 | 183 | None | 0.00% | 10 | cracks | 54% |
| | | | Texanol/BuCarb | 4.50/4.50% | 15 | excellent | 189% |
| | | | Texanol/BuCarb | 2.26/2.26% | 13 | excellent | 133% |
| Ex 8 | 0.75% NMS7/1.25% AA270 | 206 | Texanol | 2.26% | 12 | excellent | 105% |
| | | | Texanol | 4.50% | 13 | excellent | 151% |
| Ex 9 | 0.50% NMS7/0.50% AA270 | 160 | None | 0.00% | 15 | cracks | |
| | | | Texanol | 4.50% | 15 | few cracks | |
| | | | Butyl carbitol | 4.50% | 10 | few cracks | |
| | | | Butyl carbitol | 6.75% | 6 | excellent | |
| | | | DPM | 4.50% | 13 | few cracks | |
| | | | DPnB | 4.50% | 12 | excellent | |
| | | | EB | 4.50% | 9 | few cracks | |
| Ex 10 | 0.50% NMS7/0.50% D1143/0.50% AA270 | 156 | Texanol/BuCarb | 4.50/4.50% | 12 | excellent | |
| | | | Butyl carbitol | 4.50% | 3 | excellent | |
| | | | Butyl carbitol | 9.00% | 5 | excellent | |
| Ex 11 | 0.50% NMS7/1.50% AA270 (50% solids latex) | 249 | None | 0.00% | 15 | cracks | 52% |
| Ex 16 | 1.0% NMS7/0.50% D1143/0.50% AA270 | 205 | Butyl carbitol | 4.00% | 4 | excellent | |

TABLE 4
High film build masonry coating performance.
The masonry coating formulations above are applied at 10-20 mil wet film
thickness on non-porous masonry and allowed to cure at room temperature. The resulting
film was analyzed for dirt resistance, alkali resistance, effluorescence, elongation and
tensile strength.

| | | Dirt | Alkali | | | Tensile |
|---|---|---|---|---|---|---|
| | 40° F. film | resistance | resistance | Effluorescence | % | strength |
| Latex | formation | (Pass >60%) | (Pass >6) | (0 = Best) | Elongation | (psi) |
| Control | Fail | 83.4 | 8 | 1 | 201% | 457 |
| Ex. 9 | Pass | 88.1 | 8 | 1 | — | — |
| Ex. 12 | Pass | 86.0 | 8 | 1 | 76% | 458 |
| Ex. 14 | Pass | 86.7 | 4 | 5 | — | — |
| Ex. 17 | Fail | 82.0 | 8 | 1 | 161% | 529 |
| Ex. 18 | Pass | 81.8 | 8 | 2 | 112% | 369 |
| Ex. 19 | Excellent | 69.8 | 4 | 1 | 271% | 386 |
| Ex. 20 | Excellent | 72.0 | 4 | 1 | 119% | 408 |
| Ex. 21 | Excellent | 85.0 | 8 | 1 | 172% | 443 |
| Ex. 22 | Fail | 80.4 | 8 | 1 | 114% | 446 |
| Ex. 23 | Excellent | 72.2 | 8 | 1 | 63% | 394 |
| Ex. 24 | Excellent | 78.2 | 8 | 1 | 17% | 652 |

TABLE 5
High film build elastomeric roof coating performance.
The elastomeric roof coating formulations above are applied at a
wet film thickness of 15 mils or greater and allowed to cure at
room temperature. The resulting film was analyzed for elongation,
tensile strength, tear strength, permeability and water swelling.

| | Film | | Tensile | Tear | | Water |
|---|---|---|---|---|---|---|
| | thickness | % | strength | strength | Perme- | swelling |
| Latex | (mil) | Elongation | (psi) | lb/in | ability | (wt %) |
| Control | 0.021 | 126.3 | 399.3 | 76.8 | 384.2 | 4.90% |
| Ex 13 | 0.020 | 84.6 | 627.6 | 142.2 | 313.1 | 8.40% |
| Ex 21 | 0.021 | 126.8 | 642.8 | 169.3 | 243.9 | 9.90% |

What is claimed is:

1. A polymeric binder composition suitable for use in an adhesive, caulk, sealant or coating, wherein the polymeric binder is an emulsion-polymerization reaction product of a monomer mixture comprising:
a) from 0.5 to 8.0% weight percent, based on the weight of the monomer mixture, ethylenically unsaturated monomers comprising at least one ethylenically unsaturated carboxylic acid functional monomer;
b) from 0.2 to 2.0 weight percent, based on the weight of the mixture, of at least one polymerizable surfactant monomer;
c) from 0 to 2.0 weight percent, based on the weight of the mixture, of at least one polyalkylene glycol methacrylate; and
d) from 0.2 to 1.0 weight percent, based on the weight of the mixture, of an anionic polyoxyalkylate fatty alcohol surfactant.

2. The polymeric binder of claim 1, wherein the binder has a nonvolatile materials content greater than 50%.

3. The polymeric binder of claim 1, further comprising an organofunctional silane monomer.

4. The polymeric binder of claim 1, wherein the polyalkylene glycol methacrylate is polyethylene glycol methacrylate.

5. The polymeric binder of claim 4, wherein the polyethylene glycol methacrylate has an average of 7 moles of ethylene oxide units per molecule.

6. The polymeric binder of claim 1, further comprising functional monomer selected from the group consisting of acetoacetoxyethyl methacrylate, diacetoneacrylamide/adipic dihydrazide, multifunctional acrylates, multifunctional methacrylates and oxidatively crosslinking monomers.

7. A coating composition comprising a polymeric binder, wherein the polymeric binder is an emulsion-polymerization reaction product of a monomer mixture comprising:
a) from 0.5 to 8.0 weight percent, based on the weight of the monomer mixture, ethylenically unsaturated monomers comprising at least one ethylenically unsaturated carboxylic acid functional monomer;
b) from 0.2 to 2.0 weight percent, based on the weight of the mixture, of at least one polymerizable surfactant monomer;
c) from 0 to 1.0 weight percent, based on the weight of the mixture, of at least one glycidyl methacrylate; and
d) from 0.2 to 1.0 weight percent, based on the weight of the mixture, of an anionic polyoxyalkylate fatty alcohol surfactant.

8. The coating composition of claim 7, wherein the binder has a nonvolatile materials content greater than 50%.

9. The coating composition of claim 7, wherein the binder further comprises an organofunctional silane monomer.

10. The coating composition of claim 7, wherein the polymeric binder further comprises functional monomer selected from the group consisting of acetoacetoxyethyl methacrylate, diacetoneacrylamide/adipic dihydrazide, multifunctional acrylates, multifunctional methacrylates, carbodiimide, allyl ether, and oxidatively crosslinking monomers.

11. The coating composition of claim 7, wherein the volatile organic content of the coating composition is less than 100 grams/liter.

12. A method of preparing a latex emulsion polymer comprising:
a) reacting a monomer mixture comprising:
a) from 0.5 to 8.0 weight percent, based on the weight of the monomer mixture, ethylenically unsaturated monomers comprising at least one ethylenically unsaturated carboxylic acid functional monomer;
b) from 0.2 to 2.0 weight percent, based on the weight of the mixture, of at least one polymerizable surfactant monomer; and
c) from 0.2 to 1.0 weight percent, based on the weight of the mixture, of an anionic polyoxyalkylate fatty alcohol surfactant;

13. The method of claim 12, further comprising reacting the monomer mixture with a functional monomer selected from the group consisting of acetoacetoxyethyl methacrylate, diacetoneacrylamide/adipic dihydrazide, multifunctional acrylates, multifunctional methacrylates and oxidatively crosslinking monomers.

14. The method of claim 12, further comprising reacting the monomer mixture with an organofunctional silane monomer.
